(19) United States
(12) Patent Application Publication
(10) Pub. No.: US 2015/0147634 A1
(43) Pub. Date: May 28, 2015

(54) SELF-HEALING BATTERY PACK CELL-FOIL COMPOSITE

(71) Applicant: Robert Bosch GmbH, Stuttgart (DE)

(72) Inventors: Andreas NEUMANN, Eningen Unter Achalm (DE); Jens Grimminger, Leonberg (DE); Marcus Wegner, Leonberg (DE)

(21) Appl. No.: 14/547,937

(22) Filed: Nov. 19, 2014

(30) Foreign Application Priority Data
Nov. 26, 2013 (DE) 10 2013 224 069.4

(51) Int. Cl. H01M 2/02

(52) U.S. Cl. CPC H01M 2/0287; H01M 2/0277; H01M 2/0285; H01M 2/026
USPC 429/176; 29/623.1

(57) ABSTRACT

A battery pouch cell film composite having at least one metal layer, at least two adhesion promotion layers, and at least two polymer layers, at least one of the polymer layers being configured in self-healing fashion and that layer having in the interior physically delimited regions that contain at least one compound capable of polymerization.

### RELATED APPLICATION INFORMATION

The present application claims priority to and the benefit of German patent application no. 10 2013 224 069.4, which was filed in Germany on Nov. 26, 2013, the disclosure of which is incorporated herein by reference.

### FIELD OF THE INVENTION

The present invention relates to a battery pouch cell film composite encompassing at least one metal layer, at least two adhesion promotion layers, and at least two polymer layers, at least one of the polymer layers being configured in self-healing fashion, and that layer having in the interior physically delimited regions that contain at least one compound capable of polymerization.

### BACKGROUND INFORMATION

Different battery types have emerged in order to deal with the space requirements of a very wide variety of installation situations, the most common types being button cells, round cells, flat cells, or pouch cells. These cells exhibit substantially the same internal construction, with an anode, a cathode, a separator membrane that separates the cathode space from the anode space, an electrolyte/solvent, and lithium source, but they can differ appreciably in terms of their general dimensions and outer casing. The types recited first, for example, each have a rigid casing, usually made of metal or plastic, whereas the last-named battery type, the pouch cell, is surrounded only by a flexible outer envelope made of a film material which seals off the actual battery space from the environment. This difference in the construction of the outer battery cell wall has a large influence on the power-to-weight ratio of the battery cells and can be very important in the manufacture of battery modules that are made up of multiple interconnected cells. The logical result is that these have the lowest power-to-weight ratio of all the aforesaid configurations, and they are moreover notable for good cooling capability.

The high power-to-weight ratio of pouch cells comes, however, at the cost of lower mechanical strength for the outer boundary of the battery as compared with cells encased by rigid walls. This can be disadvantageous in particular when the cell is exposed to large mechanical or thermal loads. The pouch material can tear as a result of the loads, and can thus result in an uncontrolled reaction of the cell constituents of the battery.

### SUMMARY OF THE INVENTION

An object of the present invention is therefore to furnish a cell film composite for battery pouch cells which can be processed using conventional methods and which is configured in such a way that damage occurring to the film composite, such as holes or tears, can be autonomously closed up again.

It has been found, surprisingly, that a battery pouch cell film composite encompassing at least one metal layer, at least two adhesion promotion layers, and at least two polymer layers, wherein at least one of the polymer layers is configured in self-healing fashion, that layer having in the interior physically delimited regions that contain at least one compound capable of polymerization, is able to autonomously heal damage to the cell film composite and contribute to reliable operation of and an extended service life for the battery. Thanks to the self-healing layer, small to moderate injuries to the outer battery envelope can be closed up again immediately after occurrence, and an uncontrolled reaction of the battery constituents with atmospheric oxygen or atmospheric moisture can thus be prevented. It is thereby possible to induce a self-healing that is set in motion only by damage to the mechanical integrity of the envelope. Autonomous self-healing of the layer, and thus of the outer envelope of the battery, is thereby triggered.

The injury to the cell film composite, and here in particular the injury to the self-healing layer, can cause the physically delimited regions inside the polymer layer to be exposed, resulting overall in a change in the chemical environment of the compound capable of polymerization. This change in the chemical environment, for example as a result of a change in oxygen partial pressure, in the polarity of the environment, in contact with further functional groups, or in moisture, modifies the reactivity of the compounds capable of polymerization and results in a reaction of the individual compounds. This reaction can occur either entirely with one another or also with the involvement of molecules not present in the layer, for example water from atmospheric moisture, with the formation of higher-molecular-weight polymers. Formation of the higher-molecular-weight polymers causes the number of intermolecular interactions between the latter and the molecules of the remaining layer to increase, and a permanent bond between the molecules demarcating the break point can be formed in that manner.

This in-situ polymer can reclose the break point or sufficiently stabilize it mechanically. In addition, partially covalent linkages between the polymer contained in situ and the remaining compounds of the layer can also form, which can additionally result in further closure of the damage site. Immediate closure of the damage site can prevent the entry of undesired molecules from outside the cell interior, or can also minimize loss of essential cell constituents, for example the solvent. Reliable operation of the cell can thereby be guaranteed despite the damage.

Suitable battery pouch cell film composites are the film composites known in the art that can delimit the outer envelope of the pouch battery, with the provision that at least one of the layers of the cell film composite is configured in self-healing fashion as defined by the invention. The cell film composite encompasses at least one metal layer, which is usually disposed in the middle of the composite. Further layers can be applied by intermaterial connection, via adhesion promotion layers, onto this metal layer. The cell film composite can also have multiple metal layers and an accordingly proportional number of adhesion promotion layers and polymer layers; this construction also with the provision that at least one of the polymer layers is configured in self-healing fashion as defined by the invention. Besides these layers, the cell film composite can also have further layers such as outer dye or lacquer layers, or further functional layers such as diffusion-inhibiting, insulating, or mechanically stabilizing layers.

All metallic elements that substantially represent a diffusion-inhibiting barrier with respect to gases and liquids can be used as a metal layer for the cell film composite according to the present invention. Thin layers of nickel, palladium, platinum, iron, gold, silver, aluminum, or alloys thereof can be used. The metal layer can contain aluminum or be made of aluminum. The thickness of the metal layer can be greater than or equal to 1 μm and less than or equal to 500 μm, which may be greater than or equal to 5 μm and less than or equal to 200 μm.

The adhesion promotion layer can make possible an additional mechanically fixed attachment of the polymer layers among one another or to the metal layer. Layers containing polymers or polymeric compounds can be used, which layers can prevent delamination of the subsequent polymer layer. Functionalized polyolefins, polymeric silanes, polyurethanes, epoxies, or in general functionalized polymers having epoxy, vinyl, methacrylic, thiol, carboxyl, hydroxy, amino, and/or carbonyl groups, or mixtures thereof, can be used as an adhesion promotion layer.

Besides their self-healing properties, the polymer layers can contribute to mechanical stabilization of the cell film composite. The polymer layers may be polyolefin layers. These can be present in entirely or partly mechanical pretreated form, for example oriented or stretched, or in entirely mechanically untreated form. These polymer layers can be embodied from polyester, e.g. polyethylene terephthalate (PET), polyamide, polyethylene (PE), polypropylene (PP), polyvinyl chloride (PVC), polyvinyl alcohol (EVOH), epoxies, or mixtures thereof.

Physically delimited regions that have at least one compound capable of polymerization are present inside at least one polymer layer of the cell film composite. The physically delimited regions inside the polymer layer can be, for example, simple cavities inside the polymer layer. Also conceivable are cavities in said layer which additionally exhibit an inner encapsulation with respect to the polymer layer. The geometry of these delimited regions is not limited to a spherical symmetry. Rectangular, elongated, or irregularly shaped delimited regions can also be present. Elongated regions, for example, can be constituted from cylindrical cavities or can contain elongated fibers that are filled with the compound capable of polymerization.

The delimited regions can also be generated, for example, by introducing compounds capable of polymerization that are present in encapsulated form. The compounds capable of polymerization can be present in the form of microspheres or microfibers, and can be introduced into the polymer layer in the context of manufacture. In these embodiments, in the event of a mechanical load both the polymer layer and the encapsulation must be damaged in order to release the compounds capable of polymerization. Encapsulations can make sense in particular when the further layers of the cell film composite are additionally made of materials that also have functional groups. In this case, after penetration of the encapsulation, the compound capable of polymerization can additionally also react with the functional groups of the surrounding layer, and thus contribute to closure of the damage.

The compounds capable of polymerization are compounds having at least one functional group, which can react by addition, substitution, or elimination of the individual, or all, functional groups to yield higher-molecular-weight compounds, either in a homo- or copolymerization reaction or optionally a polymerization reaction with additional components as well. The term “polymerization” here encompasses chain polymerization, polycondensation, and polyaddition reactions; the chain polymerization reaction can be a radical, anionic, cationic, or coordinative chain polymerization. The compound capable of polymerization, or the corresponding compound pairs, are known to one skilled in the art.

The individual layers can furthermore contain additional additives such as ceramic particles, plasticizers, adhesion-promoting substances, stabilizers such as antioxidants, or similar adjuvants or auxiliaries.

The present invention is described in further detail below in conjunction with further aspects and embodiments. These can be arbitrarily combined with one another unless the correlation unequivocally yields the opposite.

In a particular embodiment of the invention, the self-healing layer can encompass in the interior physically delimited regions having at least two different compounds capable of polymerization. The at least two different compounds capable of polymerization can be present both physically together inside the same region of the layer, or separately from one another in respectively separate physically delimited regions of the layer. As a result of the presence of two different compounds capable of polymerization, it is advantageously possible to obtain as a result of the self-healing reaction a larger number of chemical polymers whose physical properties, such as elasticity, glass transition temperature, and adhesion to the intact layer, can be configured variably. In addition, the selection of at least two different compounds capable of polymerization also allows copolymers to be obtained whose properties can also be configured as a function of the relationship of the different co-monomers to one another. In addition, with highly reactive monomers, a physically separate disposition can advantageously allow the prevention of undesired partial reactions before initiation by damage to the self-healing layer. Examples of suitable different compounds capable of polymerization are known to one skilled in the art, for example, from the fields of polyurethane chemistry, epoxy resin chemistry, and polyester chemistry.

In a further aspect of the invention, the compound capable of polymerization can contain at least one functional group from the group encompassing alkene, alkine, hydroxy, thiol, amino, carboxy, cyano, isocyano, epoxide, acrylic, silane, silanol, alkoxy, aldehyde, carboxylic acid anhydride, carboxylic acid chloride, halogen, methacrylic, lactone. The compounds capable of polymerization can contain at least one but also several (identical or different ones) of the functional groups listed per molecule of compound. The compound capable of polymerization is able, by way of these functional groups, to enter into polyaddition, polycondensation, or other types of polymerization with itself, for example by modification of the chemical environment or by way of a catalyst, or with other compounds, at least the molecular weight of the compound capable of polymerization being raised in the course of the reaction. The compounds capable of polymerization can carry identical or different functional groups. The basic frameworks known to one skilled in the art are appropriate as compounds that carry the functional groups. These can be, for example, aliphatic or aromatic polymers, silicone compounds, acrylates, or mixtures thereof, with the provision that they carry at least one of the functional groups per molecule.

Also appropriate, furthermore, are non-polymeric compounds that carry at least one of the functional groups per molecule. Also appropriate, furthermore, are non-polymeric compounds that carry at least two of the functional groups per molecule. These compounds capable of polymerization have proven sufficiently shelf-stable in the chemical environment of the cell film composite according to the present invention, and moreover enable advantageous reaction rates in the context of the polymerization reactions, which can bring about rapid and effective closure of injuries to the cell film composite. This closure can occur selectably with or without the addition of further catalysts. Useful combination of the individual functional groups, and adaptation of the system with regard to the question as to whether the individual functional groups are present inside one physically delimited region or can be introduced only separately into the layer, are known to one skilled in the art. The molecular weight of compounds capable of polymerization can usefully be between greater than or equal to 20 and less than or equal to 1,000,000 g/mol, which may be between greater than or equal to 40 and less than or equal to 500,000 g/mol. This means that even monomers, oligomers, and/or polymers that are only terminally modified are appropriate as compounds capable of polymerization. Useful compound combinations can result, for example, from a combination of epoxies with amines, hydroxy-terminated siloxanes with ethoxy-terminated siloxanes, polyols with isocyanates, or mixtures of different acrylates.

In an embodiment the self-healing polymer layer can contain a polymerization catalyst physically separately from at least one compound capable of polymerization. The polymerization catalyst can usefully be present together with a compound capable of polymerization inside one or more of the isolated regions of the polymer layer, or inside the polymer layer itself. The first embodiment can make sense, for example, when working with two different compounds capable of polymerization inside the self-healing layer. The catalyst can then be introduced together with one component. If only one compound capable of polymerization is present inside the self-healing layer, it makes sense to introduce the catalyst into the layer itself, outside the physically delimited region. Undesired activation and polymerization in the absence of external mechanical damage can thereby be precluded.

Physical separation of the catalyst and the compound capable of polymerization when the self-healing layer is in the undamaged state ensures that activation and catalysis of the polymerization reaction occurs only upon damage to the layer. Only in this case does contact occur between the catalyst and the compound capable of polymerization, said contact resulting in polymerization and in healing of the mechanical damage. Possible polymerization catalysts are, for example, tin catalysts, platinum catalysts, WCl₆, CH₃Re(CO)₅, Grubbs' catalysts, Schrock catalysts, aluminum alkyls, aluminum alkyl chlorides, tin alkyls, WO₃ on SiO₂, Re₂O₇ on Al₂O₃, and mixtures thereof, as well as further polymerization catalysts known to one skilled in the art. Also understood as “catalysts” for purposes of the invention are polymerization initiators, polymerization accelerators, crosslinkers, radical starters, for example organic peroxides that are utilized in the context of radical polymerization, or mixtures thereof.

In an additional embodiment, the compound capable of polymerization can be suitable for metathesis polymerization, polycondensation, and/or hydrosilylation. These special conversion reactions have proven particularly effective in the sector of self-healing embodiment of layers. Without being restricted to the theory, the classes of polymerization indicated above can produce kinetically advantageous and thermally controllable reactions that can contribute to rapid closure of defects in the cell film composite. These types of polymerization can be used in particular because they are controllable in such a way that the reaction results in a change in affinity with regard to the remaining surface of the layer, which has an advantageous effect on the closure even of larger injuries.

In a further aspect of the invention, the physically delimited regions having the compound capable of polymerization can be larger than or equal to 1 μm and smaller than or equal to 300 μm. These size indications refer to the maximum dimension of the physically delimited regions inside the layer, which has a different chemical composition as compared with the layer. As indicated above, the individual regions can have a symmetrical or an asymmetrical shape. These size ranges have proven particularly advantageous because the volume of these regions, as compared with the overall dimensions of the layer, is as a rule sufficient to furnish a large enough quantity of compound capable of polymerization so that even larger injuries can be healed by the emergence and polymerization of the compound capable of polymerization. Smaller regions are not advantageous because the quantity of self-healing substance might then be too small. Larger regions can be disadvantageous because the mechanical stability of the layer may then not exist. The physically delimited regions having the compound capable of polymerization can furthermore be larger than or equal to 5 μm and smaller than or equal to 200 μm, and with further particularity larger than or equal to 10 μm and smaller than or equal to 100 μm.

In an embodiment according to the present invention, the self-healing layer can additionally encompass in the interior at least one organoleptically perceptible substance. In the context of this embodiment an organoleptically perceptible substance that can leave the layer in the context of damage, and thereby indicate mechanical damage to the layer, is present inside the layer or in the physically delimited regions. This can advantageously be utilized in order to indicate leakage of the battery pouch in general, or to characterize in more detail the location of the leak. Organoleptically perceptible substances are substances that are perceptible sensorially, i.e. in visual or olfactory fashion, by a person. These can be, for example, dyes that are present in the physically delimited regions together with the compounds capable of polymerization. As a further possibility, these can also be dyes in a leuco form that are capable of absorbing in the visible region of the light spectrum only after a chemical reaction, for example with atmospheric moisture or atmospheric oxygen. Also possible are color-imparting groups that require reaction with the monomers in order to shift their absorption spectrum in such a way that they become visually perceptible. These organoleptically active substances can, however, of course also be present only in the layer and can be triggered by the entry of an external trigger.

A further appropriate possibility for organoleptically perceptible substances is the addition of odorants, the release of which can be perceived via the occurrence of an odor. Organic sulfur compounds that are readily volatile at room temperature and have a molecular weight of less than 300 g/mol can be used for this. These odorants can be chosen, for example, from the group of mercaptans or thiophenes, for example tetrahydrothiophene (THT), or mixtures thereof. In principle, however, encapsulated fragrances, for example anethole, benzaldehyde, benzyl alcohol, citronellal, citronellol, coumarin, decanal, ethyl acetate, ethyl butanoate, ethyl vanillin, eugenol, geraniol, heliotropin, indole, isoamyl acetate, ionone, limonene, menthol, vanillin, can also be used. Also possible is the use of a sulfur-free odorant such as Gasodor S-Free. This does not, of course, affect the possibility that these substances can also be detected via technical detection systems, for example electronic noses and optical detection systems (e.g. UV spectrometers).

Also in accordance with the present invention is the use of a battery pouch cell film composite to construct a pouch battery. The cell film composite according to the present invention can be used to construct a pouch battery and can contribute, by way of its self-healing configuration, to an extension of battery service life. This results from the capability of autonomously reclosing mechanical leaks occurring in the film composite, and thus preventing the leakage of internal battery constituents or the entry of external substances, while retaining the advantages of a low power-to-weight ratio and the utilization of usual process technologies for manufacture.

In a further embodiment according to the present invention, the pouch battery can be chosen from the group encompassing lithium-ion, lithium-metal, lithium-based high-voltage, and lithium polymer batteries. These battery types in particular are notable for reactive ingredients in the interior of the battery which must be reliably protected from the entry of, for example, oxygen or moisture. The self-healing configuration according to the present invention of the battery can contribute to this by the fact that mechanical defects in the outer envelope of the battery are rapidly closed off by in-situ polymerization. “High-voltage lithium batteries” are understood for purposes of this invention as superlithiated cobalt, nickel, or manganese oxide batteries, such that the oxides of these metals can also occur in mixtures.

Also in accordance with the invention is a method for manufacturing a pouch battery, encompassing:

a) furnishing at least an anode, a cathode, a separator membrane, an electrolyte, and a lithium-ion source or lithium source, and

b) encasing the components furnished under a) with at least one self-healing battery pouch cell film composite according to the present invention.

The pouch battery can be manufactured using methods known to one skilled in the art. It is critical, however, to use a cell film composite that is configured in self-healing fashion as defined by the invention. This self-healing battery pouch cell film composite is usefully placed on the outer side of the battery or of the battery cell stack. The self-healing layer can be placed either directly on the outer side, in the interior, or on the inner side of the cell film composite which forms the outer boundary of the battery. Multiple self-healing layers can of course also be attached at multiple sites on the composite. Tears or holes can thereby be reliably closed off even in a context of only minor damage to the outer envelope. This can contribute to a longer service life for the battery. The self-healing functionality is independent of the exact configuration of the internal battery constituents, and materials familiar to one skilled in the art can consequently be used, for example, for the anode, the cathode, etc.

Also in accordance with the invention is a pouch battery that has been manufactured by the method presented according to the present invention. The pouch batteries configured in self-healing fashion according to the present invention can generally exhibit a longer service life thanks to their ability to independently repair damage to the battery envelope. The construction with self-healing layers can furthermore optionally be used to make the load-bearing layers of the cell film composite thinner, with the result that the weight-to-energy ratio of the cells is further optimized.

Regarding further advantages and features of the above-described use, reference is herewith made explicitly to the explanations in connection with the self-healing battery pouch cell film composite according to the present invention and with the method according to the present invention. Features and advantages according to the present invention of the self-healing battery pouch cell film composite according to the present invention are intended also to be applicable to the method according to the present invention and to the pouch batteries according to the present invention and to be considered disclosed, and vice versa. All combinations of at least two features disclosed in the description and/or in the claims are also embraced by the invention.

The present invention will be explained in further detail below with reference to the appended Figures.

### BRIEF DESCRIPTION OF THE DRAWINGS

FIG. 1 shows the schematic structure of a composite film according to the present invention.

FIG. 2 shows the schematic structure of a further composite film according to the present invention.

FIG. 3 shows the schematic structure of a self-healing polymer layer according to the present invention.

FIG. 4 shows the schematic structure of a further self-healing polymer layer according to the present invention.

FIG. 5 shows the schematic structure of a further self-healing polymer layer.

### DETAILED DESCRIPTION

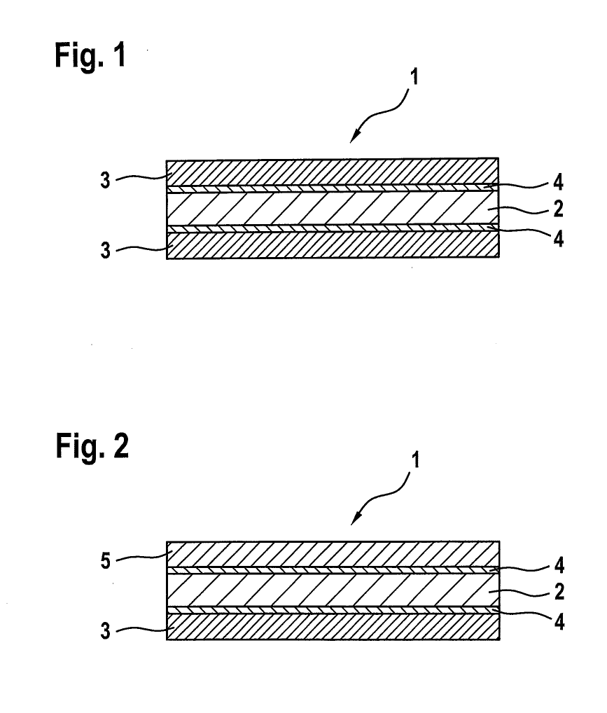

FIG. 1 shows the schematic structure of a composite film 1 according to the present invention. Located in the interior is a layer 2 made of a metal, for example aluminum, which is equipped on both sides with adhesion layers 4 and then respectively on both sides thereof with self-healing polymer layers 3.

FIG. 2 shows the schematic structure of a further composite film 1 according to the present invention. Located in the interior is a layer 2 made of a metal, for example aluminum, which is equipped on both sides with adhesion layers 4 and in this example asymmetrically on only one side, here the lower or inner side of the cell, with a self-healing polymer layer 3. The upper side is formed by a polymer layer 5 that is not configured in self-healing fashion. Also conceivable are structures in which the inner film is not configured in self-healing fashion, and the outer film is.

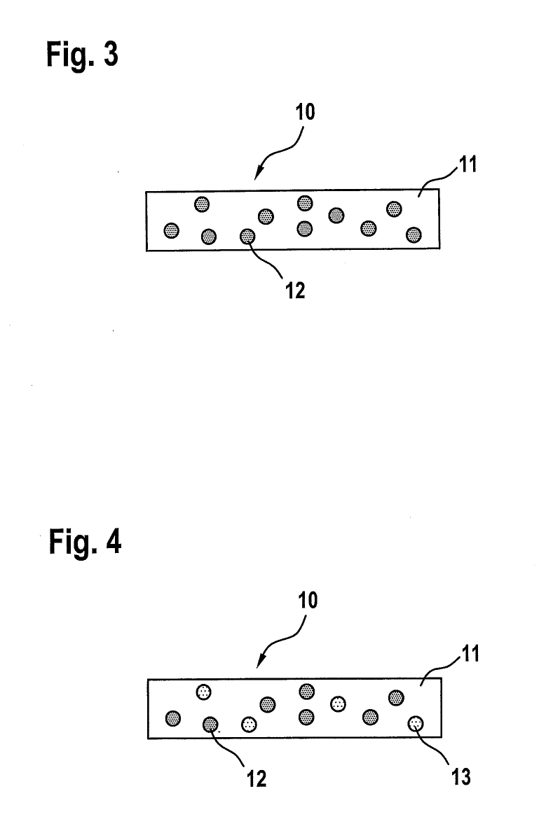

FIG. 3 shows the schematic structure of a self-healing polymer layer 10 that encompasses a polymer matrix 11 having therein physically delimited regions 12 that contain at least one compound capable of polymerization. The individual physically delimited regions do not need to be completely filled with the compound capable of polymerization. Also conceivable are situations in which they are only partly filled. The remaining region can then be filled, for example, with air or with an inert gas. Upon mechanical damage to the layer, for example due to a tear, the physically delimited regions can break open and the compound contained therein can emerge. The compound can be caused to react by an environmental trigger, for example oxygen, electrolyte, or atmospheric moisture, and can react to completion with the formation of higher-molecular-weight polymers. These higher-molecular-weight polymers can contribute to reclosing the tear in the layer or in the composite.

FIG. 4 shows the schematic structure of a further self-healing polymer layer 10 that encompasses a polymer matrix 11 having therein physically delimited regions 12 and 13, the individual regions 12 and 13 each having different compounds. According to the present invention, the compounds can be caused to react with one another.

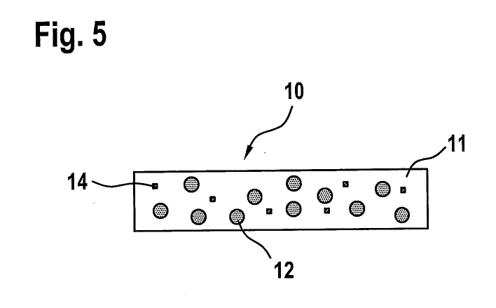

FIG. 5 shows the schematic structure of a further self-healing polymer layer 10 that encompasses a polymer matrix 11 having therein physically delimited regions 12 having at least one compound capable of polymerization and in addition catalysts 14. Catalysts 14 are physically separated from the physically delimited regions 12 having at least one compound capable of polymerization. The individual physically delimited regions can break open as a result of damage to the film, and the compound capable of polymerization can be converted to higher-molecular-weight polymers under the influence of the catalyst. These polymers can then contribute to reclosing of the tear in the layer or in the composite.

What is claimed is:

1. A battery pouch cell film composite, comprising:
at least one metal layer;
at least two adhesion promotion layers; and
at least two polymer layers;
wherein at least one of the polymer layers is configured in a self-healing manner and has in the interior physically delimited regions that contain at least one compound capable of polymerization.

2. The composite of claim 1, wherein the self-healing polymer layer encompasses in the interior physically delimited regions having at least two different compounds capable of polymerization.

3. The composite of claim 1, wherein the compound capable of polymerization contains at least one functional group from the group encompassing alkene, alkine, hydroxy, thiol, amino, carboxy, cyano, isocyano, epoxide, acrylic, silane, silanol, alkoxy, aldehyde, carboxylic acid anhydride, carboxylic acid chloride, halogen, methacrylic, lactone.

4. The composite of claim 1, wherein the self-healing polymer layer contains a polymerization catalyst physically separately from at least one compound capable of polymerization.

5. The composite of claim 1, wherein the compound capable of polymerization is suitable for at least one of metathesis polymerization, polycondensation, and hydrosilylation.

6. The composite of claim 1, wherein the physically delimited regions having the compound capable of polymerization is larger than or equal to 1 μm and smaller than or equal to 300 μm.

7. The composite of claim 1, wherein the self-healing layer additionally encompasses in the interior at least one organoleptically perceptible substance.

8. The composite of claim 1, wherein the pouch battery includes at least one of lithium-ion, lithium-metal, lithium-based high-voltage, and lithium polymer batteries.

9. A method for manufacturing a pouch battery, the method comprising:
providing components, including at least an anode, a cathode, a separator membrane, an electrolyte, and a lithium-ion source or lithium source; and
encasing the components with at least one self-healing battery pouch cell film composite;
wherein battery pouch cell film composite includes at least one metal layer, at least two adhesion promotion layers, and at least two polymer layers, wherein at least one of the polymer layers is configured in a self-healing manner and has in the interior physically delimited regions that contain at least one compound capable of polymerization.

10. The method of claim 9, wherein the self-healing polymer layer encompasses in the interior physically delimited regions having at least two different compounds capable of polymerization.

11. The method of claim 9, wherein the compound capable of polymerization contains at least one functional group from the group encompassing alkene, alkine, hydroxy, thiol, amino, carboxy, cyano, isocyano, epoxide, acrylic, silane, silanol, alkoxy, aldehyde, carboxylic acid anhydride, carboxylic acid chloride, halogen, methacrylic, lactone.

12. The method of claim 9, wherein the self-healing polymer layer contains a polymerization catalyst physically separately from at least one compound capable of polymerization.

13. The method of claim 9, wherein the compound capable of polymerization is suitable for at least one of metathesis polymerization, polycondensation, and hydrosilylation.

14. The method of claim 9, wherein the physically delimited regions having the compound capable of polymerization is larger than or equal to 1 μm and smaller than or equal to 300 μm.

15. The method of claim 9, wherein the self-healing layer additionally encompasses in the interior at least one organoleptically perceptible substance.

16. The method of claim 9, wherein the pouch battery includes at least one of lithium-ion, lithium-metal, lithium-based high-voltage, and lithium polymer batteries.
